(19) United States
(12) Patent Application Publication
(10) Pub. No.: US 2026/0307386 A1
(43) Pub. Date: Oct. 8, 2026

(54) DRIVE WAVEFORM GENERATOR, LIQUID DISCHARGE HEAD, AND LIQUID DISCHARGE APPARATUS

(71) Applicants: Yuka MIYABE, Kanagawa (JP); Masaya SHINGYOH, Kanagawa (JP)

(72) Inventors: Yuka MIYABE, Kanagawa (JP); Masaya SHINGYOH, Kanagawa (JP)

(21) Appl. No.: 19/634,147

(22) Filed: Mar. 31, 2026

(30) Foreign Application Priority Data
Apr. 2, 2025 (JP) 2025-060978

(51) Int. Cl. B41J 2/045

(52) U.S. Cl. CPC B41J 2/04588; B41J 2/04551; B41J 2/04573; B41J 2/04596; B41J 2/04581

(57) ABSTRACT

A drive waveform generator includes processing circuitry to generate a drive waveform including a plurality of driving pulses to be applied to a liquid discharge head, and the driving pulses include a combination of a discharge pulse to cause a liquid to be discharged and an excitation pulse not to cause the liquid to be discharged after the discharge pulse, for liquid discharge of a first drop, and the discharge pulse, for liquid discharge of a second drop.

### CROSS-REFERENCE TO RELATED APPLICATION

This patent application is based on and claims priority pursuant to 35 U.S.C. § 119(a) to Japanese Patent Application No. 2025-060978, filed on Apr. 2, 2025, in the Japan Patent Office, the entire disclosure of which is hereby incorporated by reference herein.

### BACKGROUND

### Technical Field

The present disclosure relates to a drive waveform generator, a liquid discharge head, and a liquid discharge apparatus.

### Background Art

Technologies to control discharge are disclosed, where the non-discharge period of every nozzle is obtained, and when there is a non-discharge period of a prescribed length of time, the size of the drop to be discharged in the initial discharging operation after such a non-discharge period has passed is increased.

### SUMMARY

The present disclosure described herein provides a drive waveform generator including processing circuitry to generate a drive waveform including a plurality of driving pulses to be applied to a liquid discharge head. The driving pulses include a combination of a discharge pulse to cause a liquid to be discharged and an excitation pulse not to cause the liquid to be discharged after the discharge pulse, for liquid discharge of a first drop, and the discharge pulse, for liquid discharge of a second drop.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic diagram of a printing apparatus according to a first embodiment.

FIG. 2 is a plan view of a discharge unit of a printing apparatus.

FIG. 3 is a cross-sectional view of a head taken in a direction perpendicular to a nozzle arrangement direction.

FIG. 4 is a cross-sectional view of a head in a nozzle arrangement direction.

FIG. 5 is a block diagram illustrating a functional configuration of a head drive controller and a head driver of a printing apparatus.

FIG. 6 is a graph illustrating the relation between discharge speed and frequency characteristics in continuous discharge according to a comparative example.

FIG. 7A and FIG. 7B are diagrams illustrating behavior from the first drop after a non-discharge period.

FIG. 8 is a diagram illustrating the discharge speed of the second drop due to the impact of residual vibration of the first drop.

FIG. 9 is a diagram illustrating a drive waveform in a discharge unit.

FIG. 10A, FIG. 10B, and FIG. 10C are diagrams each of which illustrates a drive waveform of a resonance cycle (natural-oscillation cycle) in a pressure chamber of a liquid discharge head.

FIG. 11 is a graph illustrating a time interval between an excitation pulse and a discharge pulse, indicated by N×Tc±(1/4)Tc, where Tc denotes a resonance cycle and N denotes a natural number.

FIG. 12 is a graph illustrating a time interval between an excitation pulse and a discharge pulse, indicated by N×Tc±(1/8)Tc, where Tc denotes a resonance cycle and N denotes a natural number.

FIG. 13 is a diagram illustrating a drive waveform in a discharge unit, according to a second embodiment.

FIG. 14 is a diagram illustrating a drive waveform in a discharge unit, according to a modification of the second embodiment.

FIG. 15 is a diagram illustrating a drive waveform in a discharge unit, according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A drive waveform generator, a liquid discharge head, and a liquid discharge apparatus are described below in detail with reference to the drawings.

### First Embodiment

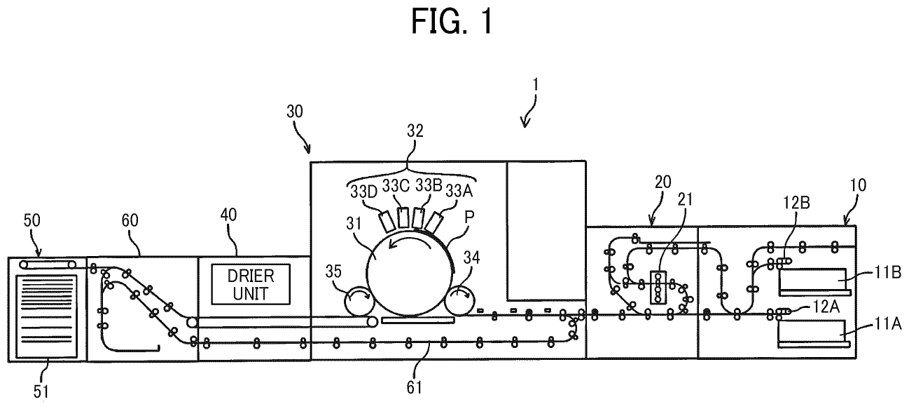

FIG. 1 is a schematic diagram of a printing apparatus 1 according to a first embodiment.

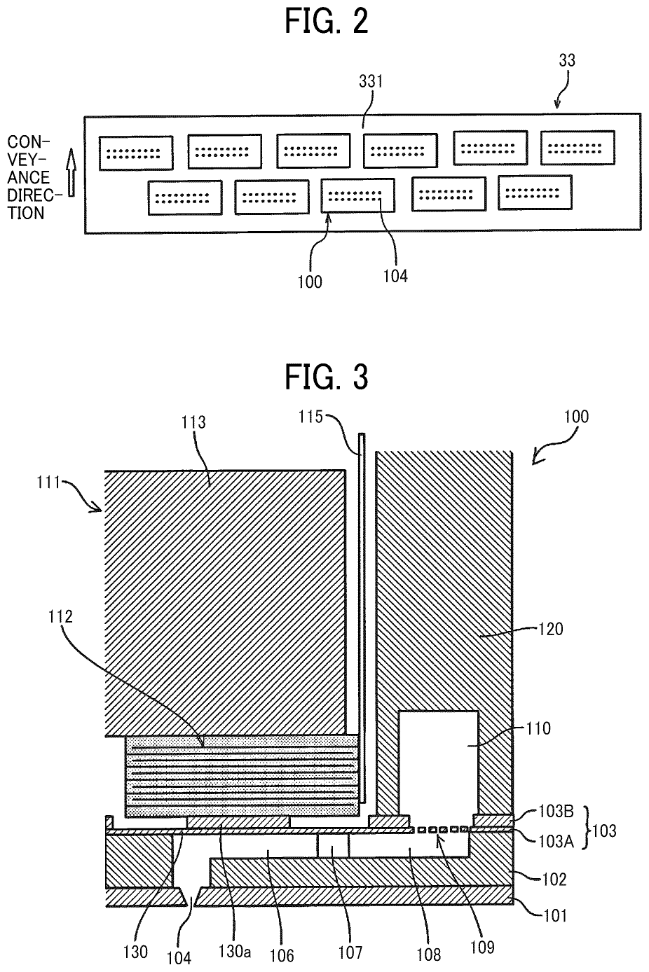

FIG. 2 is a plan view of a discharge unit 33 of the printing apparatus 1.

The printing apparatus 1 is a liquid discharge apparatus, and includes a sheet loading unit 10 to convey a sheet P, a preprocessor 20, a printer unit 30, a dryer unit 40, and a sheet ejection unit 50. In the printer 1, the preprocessor 20 applies a pretreatment liquid onto the sheet P loaded or supplied from the sheet loading unit 10 when necessary, and the printer unit 30 applies ink or liquid to the sheet P to perform printing as desired. Then, the dryer unit 40 dries the ink or liquid adhered to the sheet P, and the sheet P is ejected to the sheet ejection unit 50.

The sheet loading unit 10 is provided with a pair of sheet loading trays 11 including a lower sheet loading tray 11A and an upper sheet loading tray 11B to store a plurality of sheets P and a pair of feeders 12 including feeders 12A and 12B to feed the sheets P separately on a one-by-one basis from the sheet loading trays 11, and supplies the sheet P to the preprocessor 20.

The preprocessor 20 is provided with, for example, an applicator 21 that serves as a treatment-liquid applicator and applies treatment liquid, which has the effect of aggregating ink particles to prevent bleed-through, to the surface of the sheet P on which images are to be printed.

The printer unit 30 is provided with a drum 31 and a liquid discharge device 32. The drum 31 serves as a bearer or a rotator, and bears the sheet P on the peripheral surface and rotates. The liquid discharge device 32 discharges the liquid toward the sheet P borne on the drum 31.

The printer unit 30 is further provided with a transfer barrel 34 that receives the sheet P sent from the preprocessor 20 and passes the sheet P to the drum 31, and a transfer barrel 35 that receives the sheet P conveyed by the drum 31 and passes the sheet P to the dryer unit 40.

The transfer barrel 34 includes a sheet gripper, and that sheet gripper grips the front end of the sheet P conveyed from the preprocessor 20 to the printer unit 30. Then, the sheet P is conveyed as the transfer barrel 34 rotates. The transfer barrel 34 passes the conveyed sheet P to the drum 31 at a position facing the drum 31.

In a similar manner to the above, the drum 31 includes a sheet gripper on its surface, and the front end of the sheet P is gripped by the sheet gripper of the drum 31. A plurality of suction holes are formed on the surface of the drum 31 in a distributed manner, and a suction device generates a suction airflow directed inward from the desired ones of the suction holes of the drum 31.

The front end of the sheet P that is passed from the transfer barrel 34 to the drum 31 is gripped by the sheet gripper. Moreover, the sheet P is sucked up and borne onto the drum 31 by the suction airflow generated by the suction device, and is conveyed as the drum 31 rotates on the axis.

The liquid discharge device 32 includes discharge units 33 (i.e., discharge units 33A to 33D) to discharge liquids. For example, the discharge unit 33A discharges liquid of cyan (C), and the discharge unit 33B discharges liquid of magenta (M). Moreover, the discharge unit 33C discharges liquid of yellow (Y), and the discharge unit 33D discharges liquid of black (K). Further, the liquid discharge device 32 may adopt a discharge unit (33) that discharges special liquid, that is, ink of spot color such as white, gold, or silver.

As illustrated in FIG. 2, for example, the discharge units 33 make up a full-line head in which a plurality of liquid discharge heads 100, each of which may be referred to simply as a head in the following description and has rows of nozzles where a plurality of nozzles 104 are arrayed, are arranged in a staggered manner on a base 331.

The discharging operation of each of the discharge units 33 of the liquid discharge device 32 is controlled by a driving signal that corresponds to print data. When the sheet P borne on the drum 31 passes through an area facing the liquid discharge device 32, multicolor liquids are discharged from the discharge units 33, and an image is formed on the sheet P according to the print data.

The dryer unit 40 dries the liquid adhered to the sheet P at the printer unit 30. As a result, liquid components such as moisture in the liquid evaporate, and the colorant that is contained in the liquid is fixed on the sheet P. Additionally, the sheet P is prevented from curling.

A reversing mechanism 60 reverses the sheet P in a switchback manner when duplex printing is to be performed on the sheet P that has passed through the dryer unit 40, and the reversed sheet P is fed back to a point upstream from the transfer barrel 34 through a conveyance path 61 in the printer unit 30.

The sheet ejection unit 50 is provided with an output tray 51 on which a plurality of sheets P are stacked. The sheets P that are conveyed through the reversing mechanism 60 from the dryer unit 40 are sequentially stacked and held on the output tray 51.

FIG. 3 is a cross-sectional view of the head 100 taken in a direction perpendicular to a nozzle arrangement direction.

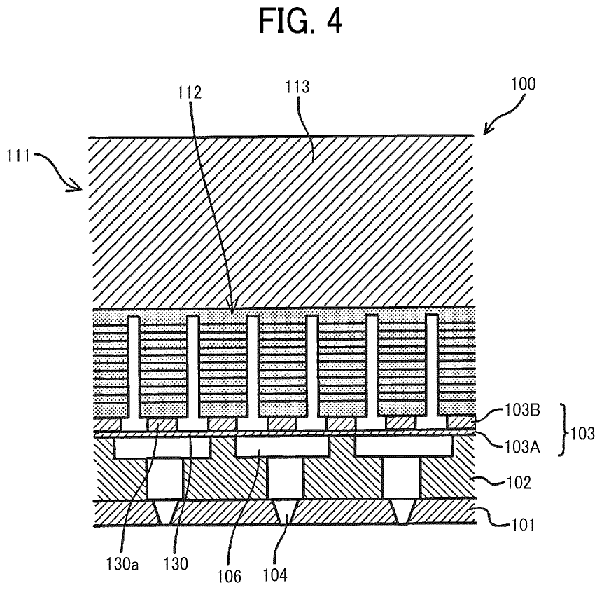

FIG. 4 is a cross-sectional view of the head 100 in a nozzle arrangement direction.

The liquid discharge head 100 has a nozzle plate 101, a channel substrate 102, and a vibration plate 103, and these elements are stacked on top of each other and bonded, where the channel substrate 102 serves as a separate pressure channel and the vibration plate 103 serves as a wall. The liquid discharge head 100 further includes a piezoelectric actuator 111 that displaces a vibration area 130 of the vibration plate 103 and a common channel 120 that also serves as the frame of the liquid discharge head 100.

The nozzle plate 101 has rows of nozzles where the nozzles 104 to discharge the liquid are arrayed.

The channel substrate 102 forms a plurality of pressure chambers 106 communicating with the nozzles 104, a plurality of selective supply channels 107 that serve as fluid restrictors and communicate with the pressure chambers 106, and an intermediate supply channel 108 that serves as a liquid introduction area and communicates with at least a pair of the selective supply channels 107.

The vibration plate 103 has a plurality of vibration areas 130 that make up the walls of the pressure chamber 106 of the channel substrate 102, and such areas are deformable and may be referred to as vibration plates in the following description. In the present embodiment, the vibration plate 103 has a two-layer structure (but not limited thereto), and includes a first layer 103A that makes up a thin portion and a second layer 103B that makes up a thick portion, which are arranged in the order listed with reference to the channel substrate 102.

The vibration areas 130 are formed in a deformable manner around the first layer 103A that is a thin-walled member, and those areas correspond to the areas of the pressure chambers 106. In the vibration areas 130, a convex portion 130a is formed that serves as a thick portion and is coupled to the piezoelectric actuator 111 in the second layer 103B.

The piezoelectric actuator 111 includes an electromechanical transducer that serves as, for example, a driver, an actuator, and a pressure generating element, and deforms the vibration areas 130 of the vibration plate 103, and is located on the other side of the pressure chamber 106 with respect to the vibration plate 103.

In the piezoelectric actuator 111, a piezoelectric member bonded on the base 113 is subjected to half-cut dicing to form grooves. Accordingly, a desired number of columnar piezoelectric elements 112 are formed at given intervals like a comb in the nozzle arrangement direction. The piezoelectric elements 112 are alternately bonded to a plurality of convex portions 130a, which are thick portions formed on the vibration area 130 of the vibration plate 103.

Each one of the piezoelectric elements 112 includes piezoelectric layers and internal electrodes that are alternately laminated in layers. The internal electrodes are separately led out to end faces and are coupled to an external electrode along the end faces, and the external electrodes are connected to a flexible wiring 115.

The common channel 120 forms a common supply channel 110. The common supply channel 110 communicates with the intermediate supply channel 108 that serves as a liquid introduction area through an opening 109 that is formed on the vibration plate 103 to serve as a filter portion, and communicates with the selective supply channel 107 through the intermediate supply channel 108.

In the liquid discharge head 100, for example, when a voltage applied to the piezoelectric element 112 is lowered below a reference potential (or an intermediate potential), the piezoelectric element 112 contracts to pull the vibration area 130 of the vibration plate 103. As a result, the volume of the pressure chamber 106 expands, and liquid flows into the pressure chamber 106.

Then, the voltage to be applied to the piezoelectric element 112 is increased to expand the piezoelectric element 112 in the direction of lamination, and the vibration areas 130 of the vibration plate 103 are deformed in directions toward the nozzles 104 to reduce the volume of the pressure chamber 106. As a result, the liquid in the pressure chamber 106 is pressurized and discharged from the nozzle 104.

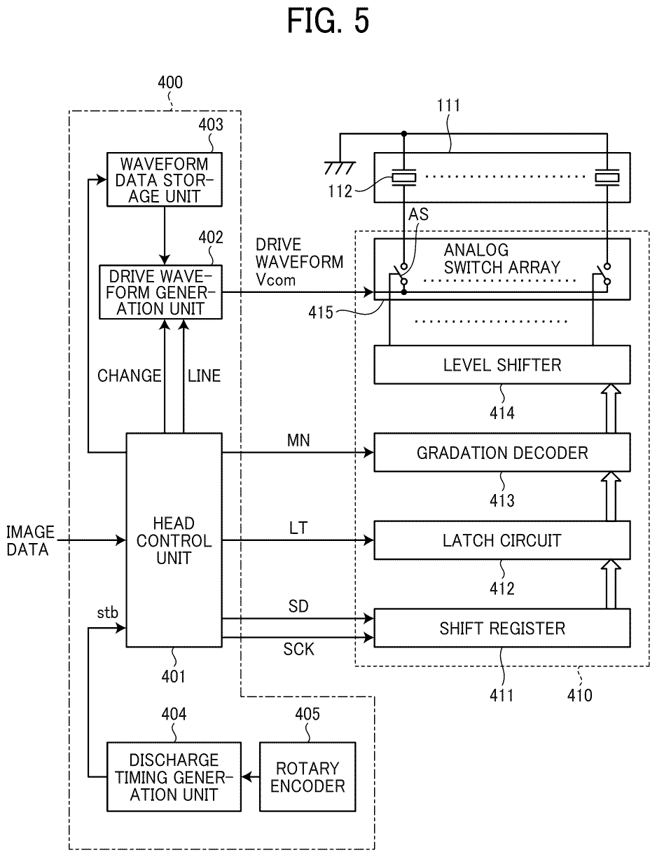

FIG. 5 is a block diagram illustrating a functional configuration of a head drive controller 400 and a head driver 410 of the printing apparatus 1.

The head drive controller 400 that gives a drive waveform to the head 100 serves as a drive waveform generator. The head drive controller 400 includes a head control unit 401, a drive waveform generation unit 402, a waveform data storage unit 403, the head driver 410, a discharge timing generation unit 404 that generates a discharge timing, and a rotary encoder 405.

Upon receiving a discharge timing pulse stb, the head control unit 401 outputs a discharge synchronizing signal LINE to the drive waveform generation unit 402, which triggers the generation of a drive waveform. The head control unit 401 outputs a discharge timing signal CHANGE corresponding to a degree of delay from the discharge synchronizing signal LINE, to the drive waveform generation unit 402.

The drive waveform generation unit 402 generates a common drive waveform Vcom at the timing based on the discharge synchronizing signal LINE and the discharge timing signal CHANGE.

The head control unit 401 receives image data and generates a mask control signal MN based on the image data. The mask control signal MN is used to select the predetermined waveform of the common drive waveform signal Vcom according to the volume of the liquid droplet to be discharged from each nozzle 104 of the head 100. The mask control signal MN is a signal indicating a time synchronized with the discharge timing signal CHANGE.

The head control unit 401 transfers image data SD, a synchronization clock signal SCK, a latch signal LT specifying the latch of the image data, and the generated mask control signal MN to the head driver 410.

The head driver 410 includes a shift register 411, a latch circuit 412, a gradation decoder 413, a level shifter 414, and an analog switch array 415.

The shift register 411 receives the image data SD and the synchronization clock signal SCK transferred from the head control unit 401. The latch circuit 412 latches each register value on the shift register 411 according to the latch signal LT transferred from the head control unit 401.

The gradation decoder 413 decodes the value (image data SD) latched by the latch circuit 412 and the mask control signal MN and outputs the result of decoding. The level shifter 414 converts the level of a logic-level voltage signal of the gradation decoder 413 to a level operable by the analog switch AS of the analog switch array 415.

The analog switch AS of the analog switch array 415 is a switch that is turned on and off by the output from the gradation decoder 413 through the level shifter 414. The analog switch AS is provided for each nozzle 104 of the head 100 and is connected to an individual electrode of the piezoelectric element 112 corresponding to each nozzle 104. The common drive waveform signal Vcom from the drive waveform generation unit 402 is input to the analog switch AS. As described above, the timing of the mask control signal MN is synchronized with the timing of the common drive waveform Vcom.

Accordingly, the analog switch AS is switched between on and off in a timely manner in accordance with the output from the gradation decoder 413 given through the level shifter 414, and the driving pulse to be applied to the piezoelectric element 112 corresponding to each nozzle 104 is selected from the driving pulses that make up the common drive waveform signal Vcom. As a result, the volume of the droplets that are discharged from the nozzle 104 is controlled as desired.

The discharge timing generation unit 404 generates and outputs the discharge timing pulse stb every time the sheet P is conveyed by a predetermined amount, based on the detection results of the rotary encoder 405 that detects the revolutions per minute (rpm) of the drum 31. The rotary encoder 405 includes an encoder wheel that rotates with the drum 31 and an encoder sensor that reads the slits of the encoder wheel.

Technologies to control discharge in an inkjet head according to a comparative example are described below.

In technologies to control discharge according to a comparative example, the size of the first drop is increased in view of dried nozzles, and variations in landing position due to the thickening caused by drying are reduced accordingly. Moreover, in technologies to control discharge according to a comparative example, the discharge speed of the first drop is made higher by the residual vibration of the microdrive waveform in the previous cycle before the first drop, or the discharge speed of the first drop is made slower to meet the discharge speed when the head 100 is driven at high frequencies.

In parallel with that, a transient response to a residual vibration may take place when an inkjet head starts discharging a liquid after a non-discharge period. This is a residual vibration of an ink supplying operation, which may be referred to as a vibration of an ink refilling operation, and is a characteristic that affects only a few drops after the first drop.

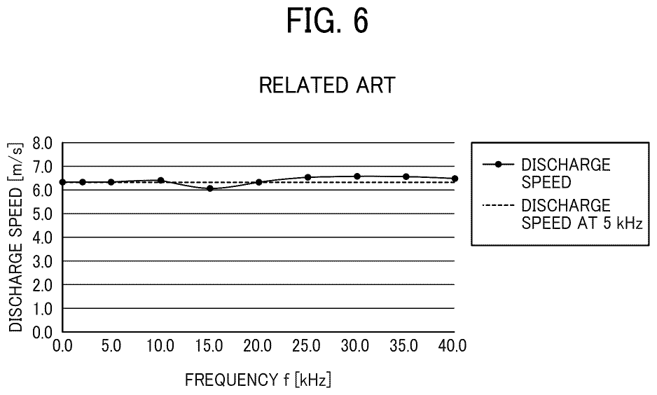

FIG. 6 is a graph illustrating the relation between discharge speed and frequency characteristics in continuous discharge according to a comparative example.

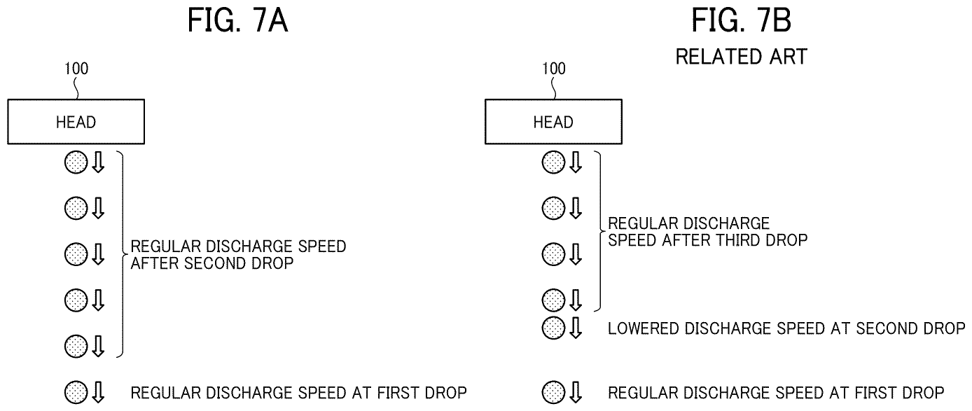

FIG. 7A and FIG. 7B are diagrams illustrating behavior from the first drop after a non-discharge period.

FIG. 7A illustrates behavior as desired, and FIG. 7B illustrates behavior according to a comparative example.

In FIG. 6, a typically-obtained result of the evaluation of discharge speeds where the drive frequency is a variable is illustrated. When the head 100 is driven at low frequencies such as 5 kilohertz (kHz) in FIG. 6, where the discharge interval on a pixel-by-pixel basis is 200 microseconds (μs), a sufficiently long time has passed after the previously-discharged drop, and the impact of residual vibration of the previously-discharged drop is almost none. For this reason, the discharge speed under such conditions becomes a basis for analysis in the graph of FIG. 6. In the graph of FIG. 6, even when the drive frequency is increased to 40 kHz, changes in discharge speed are very little, and the degree of stability is sufficiently high.

However, as illustrated in FIG. 7A and FIG. 7B, the discharging behavior in a comparative example is observed from the first drop after a non-discharge period, and it is understood that the discharge speed of the second drop decreases.

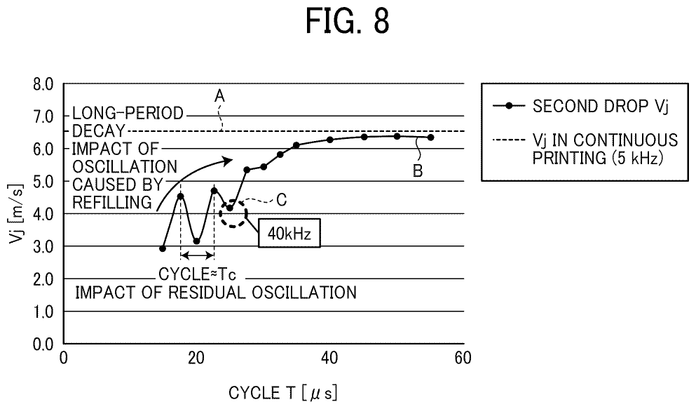

FIG. 8 is a diagram illustrating the discharge speed of the second drop due to the impact of residual vibration of the first drop.

The evaluation of the discharge speed of the second drop when the drive frequency (or drive cycle) is changed yielded results as illustrated in FIG. 8. In FIG. 8, a line A indicates the discharge speed of the first drop, and a line B indicates the discharge speed of the second drop. Moreover, a circle C on the line B indicates an area that indicates a cycle of 25 microseconds (μs) that corresponds to 40 kHz, which is the maximum frequency in the graph of FIG. 6.

When the cycle is equal to or longer than 40 microseconds (μs) and the drive frequency is low, the discharge speed of the first drop is almost equal to the discharge speed of the second drop. By contrast, when the cycle is short and the drive frequency is high, the discharge speed of the second drop is low. In view of the fact that the discharge speed gradually decreases as the cycle gets shorter than a cycle of 40 microseconds (μs), it is understood that the impact of a natural period of a short cycle is small, but the impact of a long period is strong. In other words, the residual vibration of an ink supplying operation (i.e., the oscillation caused by refilling) and the impact of residual vibration of a meniscus in a cycle equivalent to Tc are strong. It appears that the discharge speed increases around cycles of 17 microseconds (μs) or 23 μs due to the impact of a natural period. However, in its entirety, the impact of the oscillation caused by refilling is strong.

A reduction in the discharge speed of the second drop, which is caused by changes from a non-discharge state to a discharging state, as described above, cannot be addressed by technologies to control discharge according to a comparative example.

In order to handle such a situation, in the present embodiment, when the head 100 is continuously driven with discharge pulses, a waveform is adopted where an excitation pulse is inserted between the instant when the first drop has been discharged and the instant when the second drop is to be discharged. Due to such a configuration, a reduction in the discharge speed of the second drop due to the impact of residual vibration of the first drop can be prevented. This point will be described later in detail.

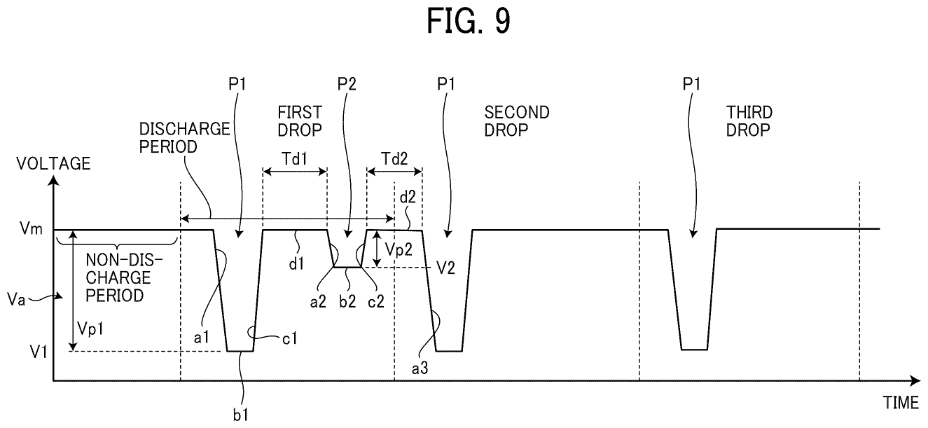

FIG. 9 is a diagram illustrating a drive waveform in a discharge unit 33.

As illustrated in FIG. 9, in a drive waveform Va according to the present embodiment where the head 100 is continuously driven with discharge pulses, excitation pulse P2 is inserted between the instant when the first drop has been discharged with discharge pulse P1 and the instant when the second drop is to be discharged with discharge pulse P1.

As illustrated in FIG. 9, the drive waveform Va includes, as a plurality of driving pulses after a non-discharge period is changed to a discharge period, discharge pulse P1 and excitation pulse P2, discharge pulse P1, and discharge pulse P1, continuously and chronologically in the order listed.

The discharge pulse P1 is a discharge pulse that applies pressure to the liquid in the pressure chamber 106 to cause the liquid to be discharged. The discharge pulse P1 is composed of, for example, an expansion waveform a1 with which the pressure chamber 106 is expanded, a keeping waveform b1 with which the pressure chamber 106 expanded with the expansion waveform a1 is kept expanded, and a contraction waveform c1 with which the pressure chamber 106 that is kept expanded by the keeping waveform b1 is contracted to discharge the liquid.

The expansion waveform a1 of the discharge pulse P1 is a waveform that falls from the intermediate potential (or reference potential) Vm to the potential V1, and the keeping waveform b1 is a waveform to keep the potential V1. The contraction waveform c1 is a waveform that rises from the potential V1 to the intermediate potential Vm. It is assumed that the peak value of this discharge pulse P1 is Vp1.

The excitation pulse P2 is a non-discharge pulse that can be used as a microdrive waveform with which the liquid inside the pressure chamber 106 is pressurized to a certain degree that the liquid is not discharged but the meniscus is vibrated. The excitation pulse P2 is composed of, for example, an expansion waveform a2 with which the pressure chamber 106 is expanded, a keeping waveform b2 with which the pressure chamber 106 expanded with the expansion waveform a2 is kept expanded, and a contraction waveform c2 with which the pressure chamber 106 that is kept expanded by the keeping waveform b2 is contracted to vibrate the meniscus.

The expansion waveform a2 of the excitation pulse P2 is a waveform that falls from the intermediate potential (or reference potential) Vm to the potential V2, where V2 is smaller than V1, and the keeping waveform b2 is a waveform to keep the potential V2. The contraction waveform c2 is a waveform that rises from the potential V2 to the intermediate potential Vm. It is assumed that the peak value of this excitation pulse P2 is Vp2.

The waveform from the endpoint of the contraction waveform c1 of the discharge pulse P1 for the first drop to the start point of the expansion waveform a2 of the excitation pulse P2 is referred to as an inter-pulse keeping waveform d1, and the length of time of the inter-pulse keeping waveform d1, which is the time interval between discharge pulse P1 and excitation pulse P2, is referred to as Td1.

The waveform from the endpoint of the contraction waveform c2 of excitation pulse P2 to the start point of the expansion waveform a3 of discharge pulse P1 for the second drop is referred to as an inter-pulse keeping waveform d2, and the length of time of the inter-pulse keeping waveform d2, which is the time interval between excitation pulse P2 and discharge pulse P1, is referred to as Td2.

The time interval Td2 between the excitation pulse P2 and the discharge pulse P1 of the second drop is in a resonant relation. When in such a resonant relation, the pressing force when the liquid inside the pressure chamber 106 is pressurized with discharge pulse P1 for the second drop is amplified due to the residual vibration when the liquid inside the pressure chamber 106 is pressurized with excitation pulse P2.

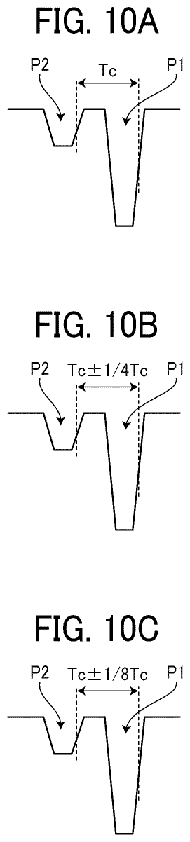

FIG. 10A, FIG. 10B, and FIG. 10C are diagrams each of which illustrates a drive waveform of a resonance cycle Tc (natural-oscillation cycle) in the pressure chamber 106 of the liquid discharge head 100.

FIG. 10A is a diagram illustrating a drive waveform where a resonance cycle (natural-oscillation cycle) Tc is the time difference between the time during which the voltage of the excitation pulse P2 changes and the time during which the voltage of the discharge pulse P1 of the second drop changes.

FIG. 10B is a diagram illustrating a drive waveform where a resonance cycle (natural-oscillation cycle) Tc±(1/4)Tc is the time difference between the time during which the voltage of the excitation pulse P2 changes and the time during which the voltage of the discharge pulse P1 of the second drop changes.

FIG. 10C is a diagram illustrating a drive waveform where a resonance cycle (natural-oscillation cycle) Tc±(1/8)Tc is the time difference between the time during which the voltage of the excitation pulse P2 changes and the time during which the voltage of the discharge pulse P1 of the second drop changes.

In the present embodiment, it is desired that the time interval Td2 between the excitation pulse P2 and the discharge pulse P1 of the second drop be within the range of N×Tc−(1/4)Tc to N×Tc+(1/4)Tc, where Tc denotes a resonance cycle (natural-oscillation cycle) in the pressure chamber 106 of the liquid discharge head 100 and N denotes a natural number.

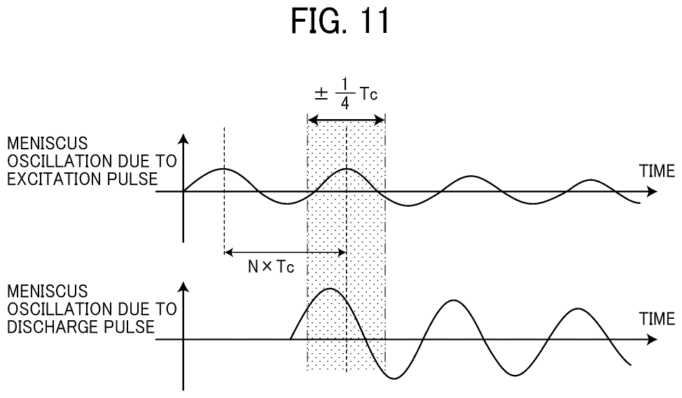

FIG. 11 is a graph illustrating a time interval between an excitation pulse and a discharge pulse, indicated by N×Tc±(1/4)Tc, where Tc denotes a resonance cycle and N denotes a natural number.

Furthermore, it is desired that such a time interval between an excitation pulse and a discharge pulse be within the range of N×Tc−(1/8)Tc to N×Tc+(1/8)Tc, where N denotes a natural number.

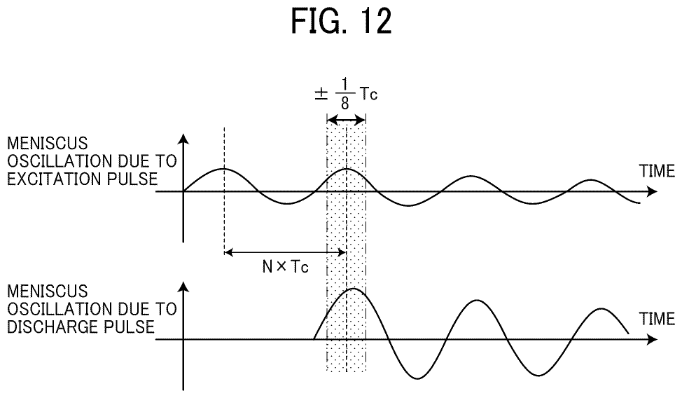

FIG. 12 is a graph illustrating a time interval between an excitation pulse and a discharge pulse, indicated by N×Tc±(1/8)Tc, where Tc denotes a resonance cycle and N denotes a natural number.

Due to such configurations as described above, the discharge speed of the second drop is to be discharged with discharge pulse P1 can be increased by the residual vibration caused by excitation pulse P2. Furthermore, residual vibrations can be utilized more efficiently in an area indicated by N×Tc±(1/8)Tc, and the influence of variations in the natural period of the head 100 can be reduced.

As described above, according to the present embodiment, even when the discharge speed of the second drop is low due to the residual vibration of the first drop, the second drop can be discharged at a discharge speed higher than the discharge speed when the second drop is discharged with a discharge pulse alone, and the second drop can be continuously discharged at a discharge speed equivalent to or close to the discharge speed for the first drop. Accordingly, a reduction in the discharge speed of the second drop due to the transient response to the residual vibration of the first drop can be prevented, and a displacement in the landing position of the second drop can be prevented. Moreover, an image of high quality can be formed.

In view of the fact that the landing of the second drop is not delayed when the drive cycle is long, in a high-resolution mode where the head 100 is driven at low frequencies and the pulse interval between the first drop and the second drop is distant, the impact of residual vibration of the first drop is so little that the discharge speed of the second drop does not decrease easily. For this reason, the present embodiment is not to be applied to a high-resolution mode where the head 100 is driven at low frequencies, and it is desired that the present embodiment be applied to a high-productivity mode where the head 100 is driven at high frequencies. In view of the above circumstances, it is not necessary to limit the pulse interval between an excitation pulse and a discharge pulse in a high-resolution mode to a resonant timing. Accordingly, the design flexibility of a drive waveform for a high-resolution mode increases, enabling the design of a drive waveform dedicated to high resolution.

### Second Embodiment

The second embodiment is different from the first embodiment in the respect that an excitation pulse is added to the second drop and the following drops. In the following description of the second embodiment, descriptions of elements identical or similar to those in the first embodiment are omitted, and the differences from the first embodiment are described.

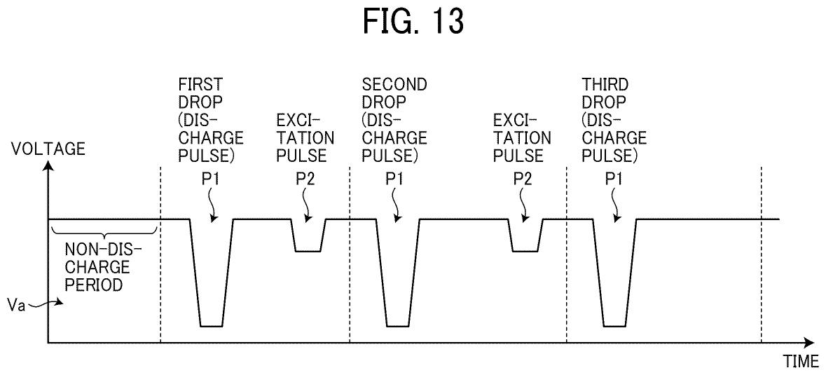

FIG. 13 is a diagram illustrating a drive waveform in the discharge unit 33, according to a second embodiment.

More specifically, FIG. 13 is a diagram illustrating a drive waveform where excitation pulse P2 is inserted between the instant when the first drop has been discharged with discharge pulse P1 and the instant when the second drop is to be discharged with discharge pulse P1 and excitation pulse P2 is inserted between the instant when the second drop has been discharged with discharge pulse P1 and the instant when the third drop is to be discharged with discharge pulse P1.

As illustrated in FIG. 13, the drive waveform Va includes, as a plurality of driving pulses after a non-discharge period is changed to a discharge period, discharge pulse P1 and excitation pulse P2, discharge pulse P1 and excitation pulse P2, and discharge pulse P1 continuously and chronologically in the order listed.

As described above, according to the present embodiment, when the discharge speed is reduced after the third drop, that discharge speed can be increased again. Due to such a configuration, the effect of excitation is applied to all the droplets whose discharge speed is reduced after the second drop, and a reduction in the discharge speed due to the transient response to the discharge of the first drop can be prevented. Accordingly, the liquid can be stably discharged.

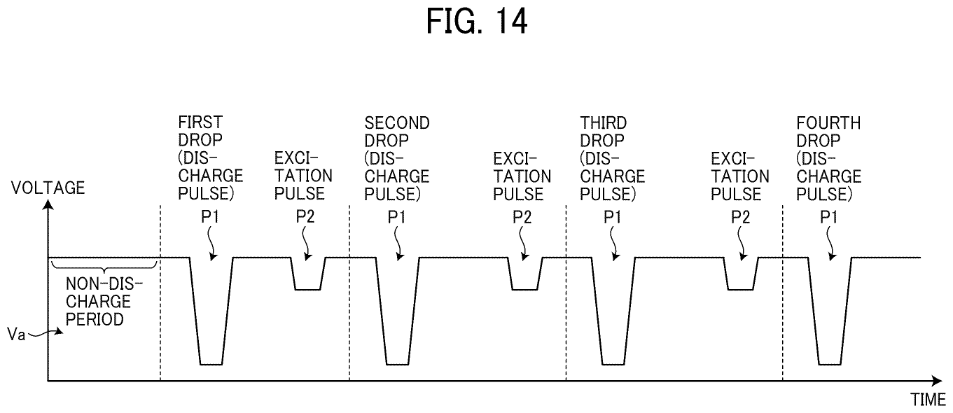

FIG. 14 is a diagram illustrating a drive waveform in the discharge unit 33, according to a modification of the second embodiment.

When the head 100 is continuously driven to discharge three or more drops of liquid with discharge pulses P1 and the impact of the residual vibration of the first drop extends to the third drop and the following drops, as illustrated in FIG. 14, the waveform of discharge pulse P1 and excitation pulse P2 may be applied to the driving pulses of the first drop as well as the second drop and the following drops. In other words, excitation pulse P2 may be added or applied not only to the first drop but also to the second drop and the following drops.

### Third Embodiment

The third embodiment is different from the first embodiment and the second embodiment of the present disclosure as described above in a respect that excitation pulses are used as microdrive pulses with which droplets are not discharged in a non-printing area. In the following description of the third embodiment, descriptions of elements identical or similar to those in the first embodiment or the second embodiment are omitted, and differences from the first embodiment and the second embodiment are described.

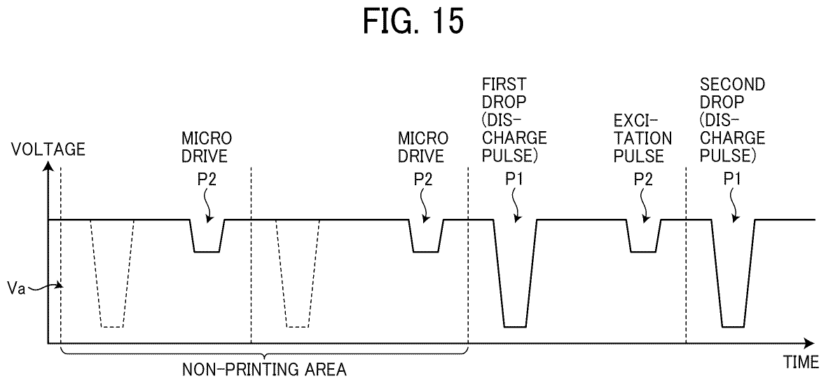

FIG. 15 is a diagram illustrating a drive waveform in the discharge unit 33, according to a third embodiment.

FIG. 15 is a diagram illustrating a drive waveform where excitation pulses P2 are used as microdrive pulses with which droplets are not discharged in a non-printing area.

As illustrated in FIG. 15, the drive waveform Va includes, as a plurality of driving pulses when a non-discharge period is changed to a discharge period, excitation pulse P2, excitation pulse P2, discharge pulse P1 and excitation pulse P2, and discharge pulse P1 continuously and chronologically in the order listed.

In the present embodiment described with reference to FIG. 15, excitation pulses P2 are used as microdrive pulses with which droplets are not discharged in a non-printing area. In such cases, excitation pulse P2 is used to prevent the meniscus in a non-printing area from being dried. Due to such a configuration, a microdrive pulse applied to a non-printing area can be shared with the excitation pulse P2 used to excite the second drop. Accordingly, the length of the drive waveform can be shortened, and the head 100 can be driven at high frequencies.

In view of the fact that the landing of the second drop is not delayed when the drive cycle is long, the present embodiment is not to be applied to a high-resolution mode where the head 100 is driven at low frequencies, and it is desired that the present embodiment be applied to a high-productivity mode where the head 100 is driven at high frequencies. In view of the above circumstances, it is not necessary to limit the pulse interval between an excitation pulse and a discharge pulse in a high-resolution mode to a resonant timing. Accordingly, the design flexibility of a drive waveform for a high-resolution mode increases, enabling the design of a drive waveform dedicated to high resolution.

In the present disclosure, the liquid discharge apparatus includes a liquid discharge head or a liquid discharge unit, and drives the liquid discharge head to discharge liquid. The liquid discharge apparatus includes not only an apparatus that discharges liquid to an object to which liquid adheres but also an apparatus that discharges liquid into liquid or the air.

The liquid discharge apparatus may include means for feeding, conveying, or ejecting an object to which liquid adheres, or may include, for example, a pretreatment device and a post-processing apparatus.

The liquid discharge apparatus may be, for example, an image forming apparatus to form an image on a sheet by discharging ink, or a three-dimensional object forming apparatus to discharge molding liquid to a powder layer in which powder material is formed in layers, so as to form a three-dimensional object.

The liquid discharge apparatus is not limited to an apparatus that uses the discharged liquid to visualize images with some meaning such as letters or figures. For example, the liquid discharge apparatus may be an apparatus that forms meaningless images such as meaningless patterns or an apparatus that fabricates three-dimensional images.

The term “object to which liquid adheres” as above denotes, for example, an object to which liquid can at least temporarily adhere, an object to which liquid adheres and is fixed, and an object to which liquid adheres and permeates. Concrete examples of the “object to which liquid adheres” include, but are not limited to, a recording medium such as a sheet of paper, recording sheet, a recording sheet of paper, a film, or cloth, an electronic component such as an electronic substrate or a piezoelectric element, and a medium such as powder layer, an organ model, or a cell for testing. The “object to which liquid adheres” includes any medium to which liquid adheres, unless otherwise specified.

Examples of the object to which liquid can adhere are satisfactory as long as they are any materials to which liquid can adhere even temporarily, such as paper, thread, fiber, fabric, leather, metal, plastic, glass, wood, and ceramic.

The term “liquid” may be any substance as long as it has viscosity or surface tension and can be discharged through the head, and is not limited to any particular liquid. It is desired that the viscosity of the liquid be equal to or lower than 30 millipascal-second (mPa·s) under normal temperature and normal atmospheric pressure or by heating or cooling. More specifically, examples of the liquid to be discharged include, for example, a solution, a suspension, and an emulsion, and those examples include, for example, solvents such as water and organic solvents, colorants such as dyes and pigments, high-performance materials or functional materials such as polymerized compounds, resin, surfactants, biomaterials such as deoxyribonucleic acid (DNA), amino acids, proteins, and calcium, and edible materials such as a natural colorants. Such a solution, a suspension, or an emulsion are used for, for example, ink for inkjet printing, surface treatment liquid, a liquid for forming components of an electronic element or light-emitting element, a liquid for forming a resist pattern of an electronic circuit, and a material liquid used to form a three-dimensional object.

Examples of the liquid discharge apparatus further include a treatment liquid applicator to discharge a treatment liquid to a sheet to coat the treatment liquid on a sheet surface to reform the sheet surface and an injection granulation system in which a composition liquid including raw materials dispersed in a solution is discharged through nozzles to granulate fine particles of the raw materials.

The terms “image formation,” “recording,” “printing,” “image printing,” and “fabricating” used herein can be used synonymously with each other.

Aspects of the present disclosure are, for example, as follows.

### First Aspect

A drive waveform generator includes a drive waveform generation unit to generate a drive waveform including a plurality of driving pulses to be applied to a liquid discharge head, and the drive waveform is a waveform where the plurality of driving pulses for liquid discharge of a first drop are a combination of a discharge pulse to cause a liquid to be discharged and an excitation pulse not to cause the liquid to be discharged after the discharge pulse and the plurality of driving pulses for liquid discharge of a second drop are the discharge pulse.

### Second Aspect

In the drive waveform generator according to the first aspect, an interval between the excitation pulse for the first drop and the discharge pulse for the second drop is in a resonant relation where pressing force of the discharge pulse for the second drop is amplified due to residual vibration caused by the excitation pulse for the first drop.

### Third Aspect

In the drive waveform generator according to the first aspect or the second aspect, a time interval between the excitation pulse for the first drop and the discharge pulse for the second drop falls within a range of N×Tc±(1/4)Tc, where N denotes a natural number and Tc denotes a resonance cycle of the liquid discharge head.

### Fourth Aspect

In the drive waveform generator according to the first aspect or the second aspect, a time interval between the excitation pulse for the first drop and the discharge pulse for the second drop falls within a range of N×Tc±(1/8)Tc, where N denotes a natural number and Tc denotes a resonance cycle of the liquid discharge head.

### Fifth Aspect

In the drive waveform generator according to the first aspect or the second aspect, a time difference between an instant when a voltage of the excitation pulse to apply pressure to the first drop changes and an instant when a voltage of the discharge pulse to apply pressure to the second drop changes falls within a range of N×Tc±(1/4)Tc, where N denotes a natural number and Tc denotes a resonance cycle of the liquid discharge head.

### Sixth Aspect

In the drive waveform generator according to the first aspect or the second aspect, a time difference between an instant when a voltage of the excitation pulse to apply pressure to the first drop changes and an instant when a voltage of the discharge pulse to apply pressure to the second drop changes falls within a range of N×Tc±(1/8)Tc, where N denotes a natural number and Tc denotes a resonance cycle of the liquid discharge head.

### Seventh Aspect

In the drive waveform generator according to any one of the first aspect to the sixth aspect, when the liquid discharge head is continuously driven to discharge three or more drops of the liquid with the discharge pulse, the drive waveform is a waveform where the excitation pulse is added before the discharge pulse in the plurality of driving pulses for liquid discharge of the second drop and following drops.

### Eighth Aspect

In the drive waveform generator according to any one of the first aspect to the seventh aspect, the excitation pulse is used alone as a microdrive pulse of microdrive waveform to vibrate a meniscus to a degree that the liquid is not discharged in a non-printing area.

### Ninth Aspect

In the drive waveform generator according to any one of the first aspect to the eighth aspect, the drive waveform is not applied to a high-resolution mode where the liquid discharge head is driven at a low frequency, and the drive waveform is applied to a high-productivity mode where the liquid discharge head is driven at a high frequency.

### Tenth Aspect

A liquid discharge head includes the drive waveform generator according to any one of the first aspect to the ninth aspect.

### Eleventh Aspect

A liquid discharge apparatus includes a liquid discharge head and the drive waveform generator according to any one of the first aspect to the ninth aspect.

According to one aspect of the present disclosure, a reduction in the discharge speed of the second drop due to the transient response to the residual vibration of the first drop can be prevented, and a displacement in the landing position of the second drop can be prevented.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A drive waveform generator comprising
processing circuitry configured to generate a drive waveform including a plurality of driving pulses to be applied to a liquid discharge head,
the plurality of driving pulses including:
a combination of a discharge pulse to cause a liquid to be discharged and an excitation pulse not to cause the liquid to be discharged after the discharge pulse, for liquid discharge of a first drop; and
the discharge pulse, for liquid discharge of a second drop.

2. The drive waveform generator according to claim 1,
wherein an interval between the excitation pulse for the first drop and the discharge pulse for the second drop is in a resonant relation where pressing force of the discharge pulse for the second drop is amplified due to residual vibration caused by the excitation pulse for the first drop.

3. The drive waveform generator according to claim 1,
wherein a time interval between the excitation pulse for the first drop and the discharge pulse for the second drop falls within a range of N×Tc±(1/4)Tc, where N denotes a natural number and Tc denotes a resonance cycle of the liquid discharge head.

4. The drive waveform generator according to claim 1,
wherein a time interval between the excitation pulse for the first drop and the discharge pulse for the second drop falls within a range of N×Tc±(1/8)Tc, where N denotes a natural number and Tc denotes a resonance cycle of the liquid discharge head.

5. The drive waveform generator according to claim 1,
wherein a time difference between an instant when a voltage of the excitation pulse to apply pressure to the first drop changes and an instant when a voltage of the discharge pulse to apply pressure to the second drop changes falls within a range of N×Tc±(1/4)Tc, where N denotes a natural number and Tc denotes a resonance cycle of the liquid discharge head.

6. The drive waveform generator according to claim 1,
wherein a time difference between an instant when a voltage of the excitation pulse to apply pressure to the first drop changes and an instant when a voltage of the discharge pulse to apply pressure to the second drop changes falls within a range of N×Tc±(1/8)Tc, where N denotes a natural number and Tc denotes a resonance cycle of the liquid discharge head.

7. The drive waveform generator according to claim 1, wherein when the liquid discharge head is continuously driven to discharge three or more drops of the liquid with a plurality of discharge pluses including the discharge pulse, the plurality of driving pulses include a combination of one of the plurality of discharge pulses and the excitation pulse added before next one of the plurality of discharge pulses, for liquid discharge of the second drop and following drops.

8. The drive waveform generator according to claim 1,
wherein the excitation pulse is used alone as a microdrive pulse of microdrive waveform to vibrate a meniscus to a degree that the liquid is not discharged in a non-printing area.

9. The drive waveform generator according to claim 1,
wherein the drive waveform is not applied to a high-resolution mode where the liquid discharge head is driven at a low frequency, and
wherein the drive waveform is applied to a high-productivity mode where the liquid discharge head is driven at a high frequency.

10. A liquid discharge head comprising
the drive waveform generator according to claim 1.

11. A liquid discharge apparatus comprising:
a liquid discharge head; and
the drive waveform generator according to claim 1.
